(19) United States
(12) Patent Application Publication
(10) Pub. No.: US 2016/0375492 A1
(43) Pub. Date: Dec. 29, 2016

(54) APPLICATION OF MAGNETIC FIELDS IN ADDITIVE MANUFACTURING

(71) Applicants: Christopher Dennis Bencher, Cupertino, CA (US); Joseph Robert Johnson, Redwood City, CA (US)

(72) Inventors: Christopher Dennis Bencher, Cupertino, CA (US); Joseph Robert Johnson, Redwood City, CA (US)

(21) Appl. No.: 15/188,799

(22) Filed: Jun. 21, 2016

Related U.S. Application Data
(60) Provisional application No. 62/184,145, filed on Jun. 24, 2015.

(51) Int. Cl. B22F 3/24; B33Y 40/00; B33Y 50/02; B22F 3/105; B33Y 30/00; B33Y 10/00

(52) U.S. Cl. CPC B22F 3/24; B33Y 30/00; B33Y 10/00; B33Y 50/02; B22F 3/1055; B33Y 40/00

(57) ABSTRACT

An additive manufacturing system includes a support, a dispenser to deliver a layer of metallic powder onto the support or an underlying layer on the support, an energy source to fuse at least a portion of the layer of metallic powder, and a magnet positioned and configured to apply a magnetic field to the portion of the layer of metallic powder as the layer is fused.

### CROSS-REFERENCE TO RELATED APPLICATIONS

This application claims priority to U.S. Provisional Application Ser. No. 62/184,145, filed on Jun. 24, 2015, the contents of which are incorporated by reference.

### TECHNICAL FIELD

This present invention relates to additive manufacturing, also known as 3D printing.

### BACKGROUND

Additive manufacturing, also known as solid freeform fabrication or 3D printing, refers to any manufacturing process where three-dimensional objects are built up from raw material (generally powders, liquids, suspensions, or molten solids) in a series of two-dimensional layers or cross-sections. In contrast, traditional machining techniques involve subtractive processes and produce objects that are cut out of a stock material such as a block of wood, plastic or metal.

A variety of additive processes can be used in additive manufacturing. The various processes differ in the way layers are deposited to create the finished objects and in the materials that are compatible for use in each process. Some methods melt or soften material to produce layers, e.g., selective laser melting (SLM) or direct metal laser sintering (DMLS), selective laser sintering (SLS), fused deposition modeling (FDM), while others cure liquid materials using different technologies, e.g., stereo lithography (SLA).

Sintering is a process of fusing small grains, e.g., powders, to creating objects from smaller grains, e.g., powders using atomic diffusion. Sintering usually involves heating a powder. The powder used in sintering need not reach a liquid phase during the sintering process, in contrast to melting. When a powdered material is heated to a temperature below the melting point in a sintering process, the atoms in the powder particles diffuse across the boundaries of the particles, fusing the particles together to form a solid piece. As the sintering temperature does not have to reach the melting point of the material, sintering is often used for materials with high melting points such as tungsten and molybdenum.

Both sintering and melting can be used in additive manufacturing. The material being used determines which process occurs. An amorphous solid, such as acrylonitrile butadiene styrene (ABS), is actually a supercooled viscous liquid, and does not actually melt; as melting involves a phase transition from a solid to a liquid state. Thus, selective laser sintering (SLS) is the relevant process for ABS, while selective laser melting (SLM) is used for crystalline and semi-crystalline materials such as nylon and metals, which have a discrete melting/freezing temperature and undergo melting during the SLM process.

Conventional systems that use a laser beam as the energy source for sintering or melting a powdered material typically direct the laser beam on a selected point in a layer of the powdered material and selectively raster scan the laser beam to locations across the layer. Once all the selected locations on the first layer are sintered or melted, a new layer of powdered material is deposited on top of the completed layer and the process is repeated layer by layer until the desired object is produced.

### SUMMARY

In one aspect, an additive manufacturing system includes a support, a dispenser to deliver a layer of metallic powder onto the support or an underlying layer on the support, an energy source to fuse at least a portion of the layer of metallic powder, and a magnet positioned and configured to apply a magnetic field to the portion of the layer of metallic powder as the layer is fused.

In another aspect, a method of additive manufacturing includes delivering a layer of metallic powder onto a support or an underlying layer on the support, processing at least a portion of the layer of metallic powder to fuse the portion, and applying a magnetic field to the portion of the layer of metallic powder as the portion is processed.

Implementations of the system or method may include one or more of the following. The magnet may be oriented such that magnetic field lines of the magnetic field passing through the portion of the layer extend perpendicular to the layer. The magnet may be oriented such that magnetic field lines of the magnetic field passing through the portion of the layer extend perpendicular to the layer.

The metallic powder may be a ferromagnetic material, and the magnet may be configured to generate a magnetic field of about 50-500 gauss. The metallic powder may be a diamagnetic or paramagnetic material, and the magnet may configured to generate a magnetic field of about 1-15 Tesla.

The magnet may include an electromagnet. A controller may be coupled to the electromagnet and the energy source. The electromagnet may include a first electromagnet to generate a first magnetic field and a second electromagnet to generate a second first magnetic field substantially perpendicular to the first magnetic field. The controller may be configured to control power to the first electromagnet and second electromagnet so as to generate a magnetic field in the portion of the layer at a selectable orientation. The controller is may be configured to control power to the electromagnet such that the magnetic field has a first orientation during processing of powder of a first layer and a different second orientation during processing of powder of a subsequent second layer. The first orientation may be perpendicular to the second orientation. The controller may be configured to control power to the electromagnet such that the magnetic field has a same orientation during fusing of powder of a first layer and an adjacent second layer. The controller may be configured to control power to the electromagnet to start generating the magnetic field in the portion of the layer of metallic powder while the portion is being heated by the energy source. The controller may be configured to control power to the electromagnet to start generating the magnetic field in the portion of the layer of metallic powder while the portion is cooling from being heated by the energy source.

The magnet may include a permanent magnet. The magnet may be configured to apply the magnetic field across all of the layer of metallic powder. The energy source may be configured to apply heat to raise the temperature of all of the layer of metallic powder simultaneously. The energy source may include an array of heat lamps. The energy source may be configured to apply heat to raise the temperature in a first localized region of the layer of metallic powder and to scan the region across the layer. The energy source may be configured to apply heat in a first localized region of the layer of metallic powder and to scan the region across the layer, and the magnet may be configured to generate the magnetic field in a second localized region that includes the first localized region. The energy source may include a laser.

The magnet may include a pair of magnets positioned on opposite sides of the platen. The pair of magnets comprise electromagnets having collinear coils. A linear actuator may be coupled to the support to move the support vertically.

Implementations can provide one or more of the following advantages. The size and alignment of grains within a material, e.g., a ferrous metal, can be controlled more reliably, and consequently the size and alignment of the material's constituent grains can be more uniform or have selected non-uniformity. Material properties of the fabricated object can be more spatially uniform. Material strength can be made to be stronger or weaker in particular directions. Material properties such as conductivity can also be increased or decreased.

The details of one or more embodiments are set forth in the accompanying drawings and the description below. Other aspects, features, and advantages of the invention will be apparent from the description, drawings, and from the claims.

### DESCRIPTION OF DRAWINGS

FIG. 1 is a schematic side view of an additive manufacturing system using a dispenser and laser heat source, with a magnetic field applied parallel to the surface of the deposited material.

FIG. 2 is a schematic side view of an additive manufacturing system using a platen roller and laser heat source, with a magnetic field applied parallel to the surface of the deposited material.

FIG. 3 is a schematic side view of an additive manufacturing system using a dispenser and lamp array heat source, with a magnetic field applied perpendicular to the surface of the deposited material.

FIG. 4 is a schematic side view of an additive manufacturing system using a dispenser and laser heat source, with a magnetic field applied perpendicular to the surface of the deposited material.

FIG. 5 is a schematic side view of an additive manufacturing system using a dispenser and a laser heat source, with a magnetic field applied parallel to the surface of the deposited material and a magnetic field applied perpendicular to the same surface.

FIG. 6 is a schematic top view of an additive manufacturing system using a platen roller and a lamp array heat source, with a magnetic field applied parallel to the surface of the deposited material and a magnetic field applied perpendicular to the same surface.

### DETAILED DESCRIPTION

Additive manufacturing is a process where an object is fabricated one layer at a time. One form of additive manufacturing dispenses a layer of powder onto a platen or an underlying layer on the platen, and then applies heat to fuse the powder, e.g., by a process of selective laser sintering or selective laser melting. In general, as the manufactured material cools and settles, the grain size and grain alignment, i.e., the crystallographic lattice orientation of the grain, is typically distributed randomly throughout the material. However, for metallic powders, the application of magnetic fields during the manufacturing process can improve uniformity of grain size and alignment throughout the layer of material. The magnetic field can pass through the portion of the material being fused in order to align the grains within the material as they cool and set. For example, for ferromagnetic materials, magnetic fields can be used to align the grains within the material. As each layer is dispensed, both the size and direction of the grains within the layer can be manipulated through the use of either electromagnets or permanent magnets positioned to apply a magnetic field to the layer.

The magnetic field may be produced by a single magnet or by an array of magnets arranged in a magnet assembly. In addition, for some implementations, the position and direction of individual magnets can be controlled independently. Applying magnetic fields of different strength and direction can provide different properties for the different material layers. For example, applying a magnetic field parallel to the layer of material will result in grains that are all aligned in a horizontal orientation, whereas applying a magnetic field perpendicular to the layer of material will result in grains that are aligned in a vertical orientation. Furthermore, applying alternating magnetic fields to alternating layers of a material will result in a fabricated product that contains alternating orientations of the grains.

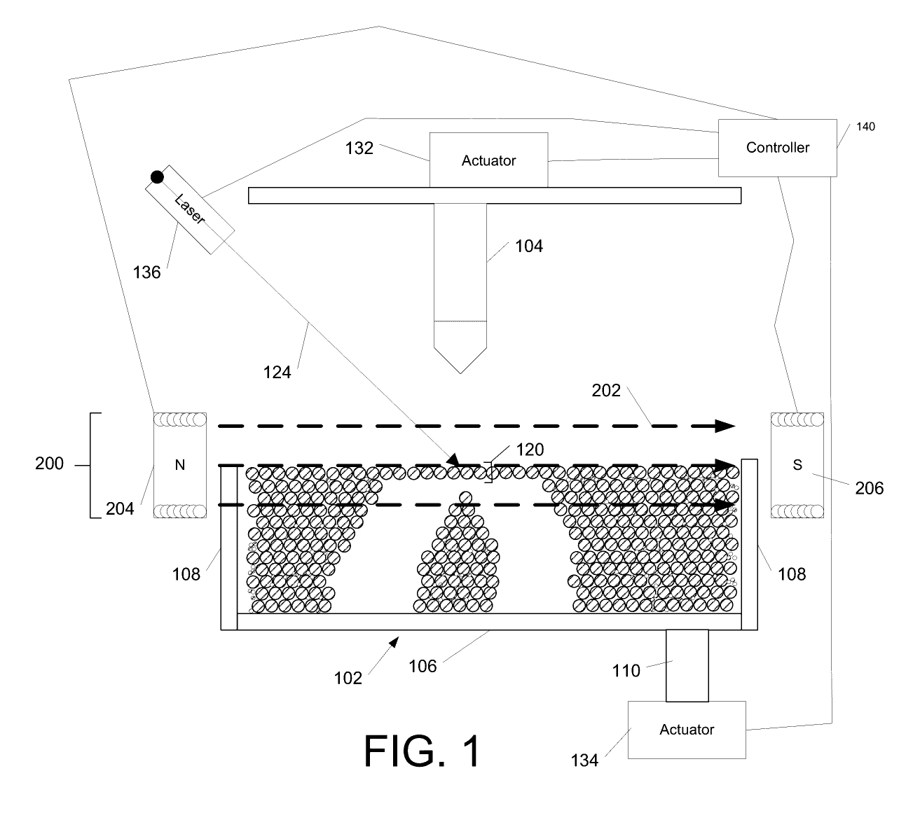

FIG. 1 is a schematic illustration of an exemplary additive manufacturing system 100. The additive manufacturing system 100 includes a support 102 to support the object being fabricated, a dispenser 104 to deliver a layer 120 of feed material, e.g., a metallic powder, onto the support 102 or an underlying layer on the support, and an energy source 136 to fuse at least a portion of the outermost layer 120 of feed material, e.g., by sintering or melting. The feed material can be a precursor for the material of the object to be fabricated. The additive manufacturing system 100 also includes a magnet 200 positioned and configured to apply a magnetic field 202 to at least the portion of the layer of powder that is being fused as the layer is fused.

The support 102 can include a platen 106 that is vertically movable by an actuator 134. For example, a vertical position of the platen 106 can be controlled by a piston 110 coupled to the actuator 134. The support 102 can also include the walls 108 to hold the feed material. As the layer of feed material is dispensed over the platen, the walls 108 can constrain the feed material to the top of the platen 106. The walls 108 can be a magnetically permeable material.

The powder 120 is a magnetically susceptible material. In some implementations, the powder 120 is a ferromagnetic material, such as a ferrous material, although the powder could be a paramagnetic material or diamagnetic material. Possible materials include metals, including transition metals, post-transition metals, and metalloids. Example metals include palladium, manganese, bismuth, niobium, platinum, titanium, antimony, molybdenum, tungsten, tin, gold, silver, copper, iron, steel, and alloys and intermetallics thereof. Possible materials also include alkaline earth metals and lanthanides.

In some implementations, e.g., as shown in FIG. 1, the dispenser includes a dispenser assembly 104 that is positioned over the support 102 and is configured to eject or deposit the powder onto the platen 106 or underlying layer. For example, the dispenser assembly 104 can include one or more openings through which the powder is delivered downwardly over the platen 106. Relative motion between the dispenser assembly 104 and the support 102 can be provided by one or more linear actuators 132 and/or 134 that are connected to and move the support 102 and/or the dispenser 104.

In some implementations, the dispenser assembly 104 delivers the powder particles in a carrier fluid, e.g. a high vapor pressure carrier, to form the layer of powder material. The carrier fluid can evaporate prior to the fusing step for the layer.

In some implementations, the dispenser assembly 104 includes a plurality of openings through which the feed material is dispensed. Each opening can have an independently controllable gate, so that delivery of the feed material through each opening can be independently controlled. In some implementations, the plurality of openings extend across the width of the platen, e.g., in direction perpendicular to the direction of travel of the dispenser assembly 104 during a scan. In this case, in operation, the dispenser assembly 104 can scan across the support 102 and deposit the layer 120 in a single sweep. Alternatively, the dispenser assembly 104 can move in two perpendicular directions to scan across the platen 106, e.g., a raster scan across the platen 106. As the dispenser assembly 104 scans across the platen, the dispenser assembly 104 deposits feed material at an appropriate location on the platen 106 according to a printing pattern that can be stored as a computer aided design (CAD)-compatible file that is then read by a computer associated with the controller 140.

In some implementations, rather than ejecting the powder from an opening, the powder is pushed from a dispensing bed adjacent the support. For example, as shown in

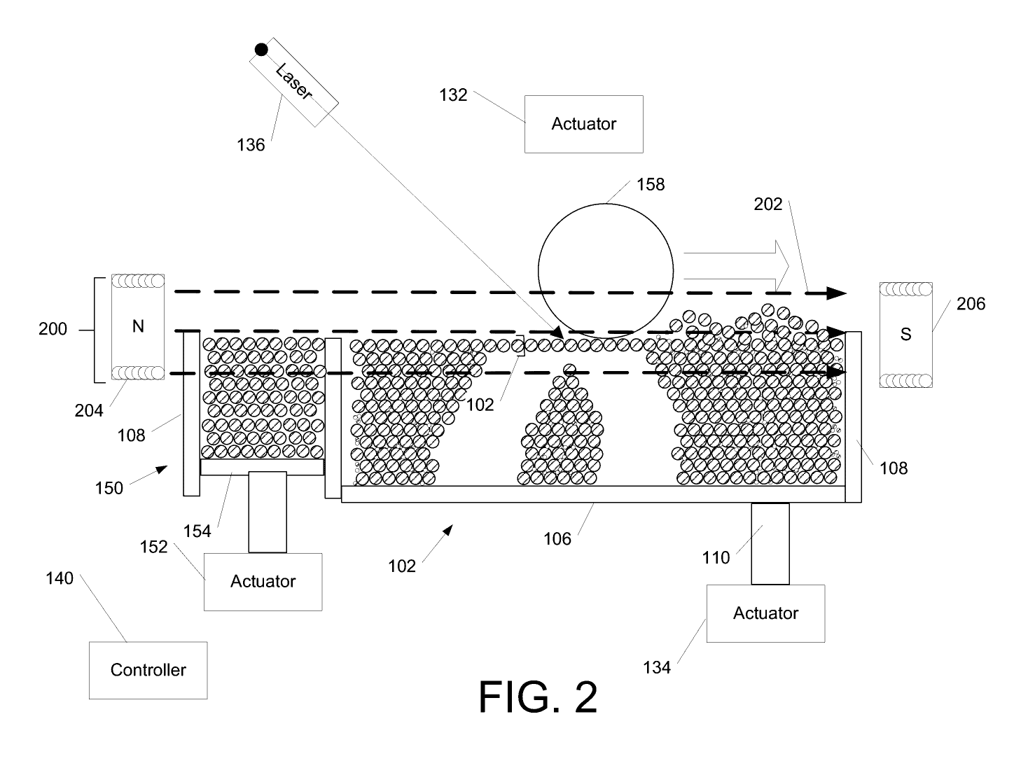

FIG. 2, the dispenser includes a powder delivery bed 150 adjacent the support 102. A wall 108 can separate the powder delivery bed 150 from the support 102. An actuator 152, e.g., a piston, controls the vertical motion of a delivery platen 154. In operation, for each layer, the platen 154 is raised vertically by a height that will provide sufficient powder particles to form a layer of uniform thickness over the support 102. The dispenser also includes a powder delivery device 158, e.g. a blade or a roller, to push powder from the delivery bed 150 over the support 102 to form the layer 120 of powder material. Relative motion between the device 158 and the support 102 and delivery bed 150 can be provided by a linear actuator coupled to the device 158 and/or the support 102.

A controller 140 controls the actuators that are connected to the movable components of the dispenser assembly. The drive system is configured such that, during operation, the dispenser assembly is movable back and forth parallel to the top surface of the platen 106 (along the direction indicated by arrow 106). For example, the dispenser 104 or roller 158 can be supported on a horizontal rail.

Returning to FIG. 1, for some implementations, e.g., where the feed material is be deposited uniformly on the platen 106, the energy source can be configured to heat specified locations to cause fusing of the powder at the specified locations. A beam 124 from the energy source can be scanned across the layer of feed material, and the power modulated as specified by a printing pattern stored as a computer aided design (CAD)-compatible file to selectively control which portions of the layer of feed material are fused. For example, the energy source can be a laser source and the beam 124 can be a laser beam, or the energy source can be an electron source and the beam 124 can be an electron beam, e.g., if the magnetic field lines are oriented parallel to the electron beam.

To provide scanning of the beam 124 across the platen 106, the platen 106 and energy source can remain stationary while the beam 124 is scanned, e.g., by a mirror galvanometer in the case of a laser or deflection by electrostatic plates in the case of an ion beam. Alternatively, the laser beam 124 can remain stationary while the platen 106 is horizontally displaced. Alternatively, the platen 106 can remain stationary while the laser source 124 is horizontally moved, e.g., by a linear actuator.

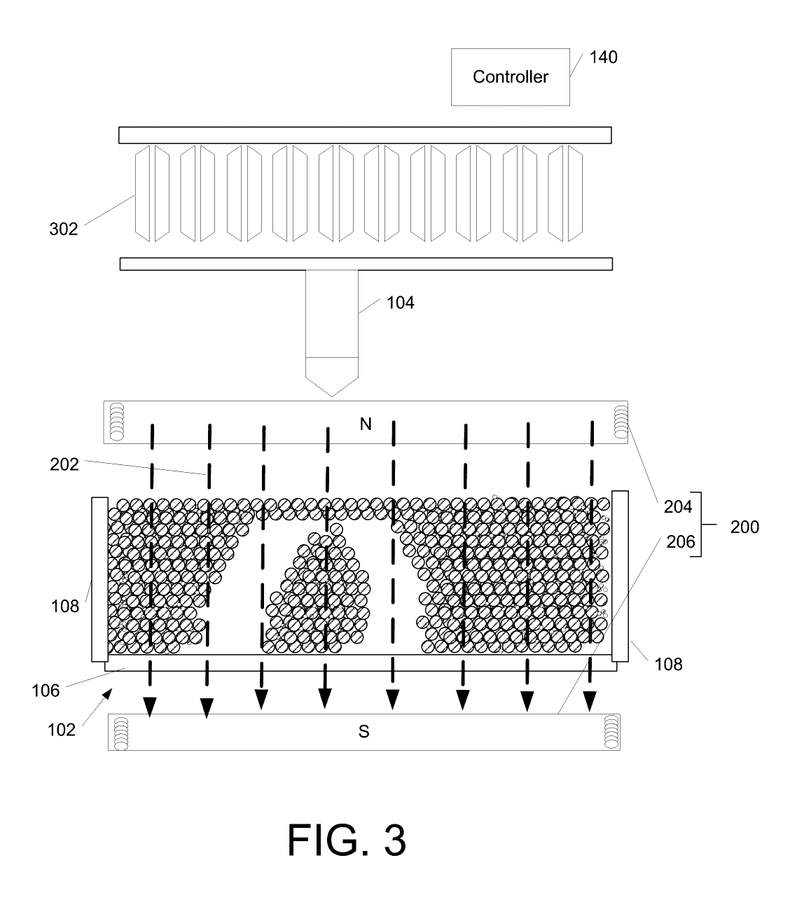

For example, a laser beam 124 from a laser source 136 can be scanned across the platen 106, to selectively heat any particular area on the surface of the layer of feed material. The power of the laser beam 124 can be modulated as a function of locations specified by the CAD file to selectively fuse the feed material at those locations. Alternatively, for some implementations, e.g., where the feed material is selectively dispensed in a pattern, the energy source can heat the entire layer simultaneously. For example, referring to FIG. 3, the energy source could be a lamp array 302 positioned above the platen 104 that radiatively heats and thereby fuses the entire layer 120 of feed material simultaneously. The magnet 200 can be a permanent magnet or an electromagnet. As a permanent magnet, in some implementations, the magnet can be connected to an actuator in order to be moved to different orientations. As an electromagnet, the strength of the magnetic field can be controlled by adjusting the electric voltage applied to the electromagnet.

In some implementations, the magnet 200 is held in a fixed position on a frame in the system 100. However, in some implementations, the magnet 200 is movable, e.g., connected to a linear actuator that moves the magnet relative to the frame. For example, the controller 140 can operate the linear actuator to move the magnet 200 out of the way of components of the dispenser system to avoid collision during the dispensing process.

As shown in FIGS. 1-4, the magnet 200 can be a magnet assembly that includes a pair of magnets 204, 206 positioned on opposite sides of the support 102 so that the magnets 204, 206 generate a magnetic field with substantially parallel field lines in the portion of the layer of powder that is being fused. For example, the magnet assembly 200 can include a pair of electromagnets 204, 206 with co-linear coils. In particular, the magnetic field 202 can be applied while the material is cooling after being heated by the energy source. For example, if magnet 200 includes an electromagnet, the electromagnet can be energized during this time period.

The magnetic field strength sufficient to improve grain alignment depends on the material of the object being fabricated. For example, for ferromagnetic materials, such as iron or steel, a magnetic field strength as low as about 50 gauss may be sufficient. For example, the magnetic field strength may be between 50-500 gauss. On the other hand, for paramagnetic or diamagnetic materials, a system can be constructed with a vastly more powerful magnet, e.g., a magnetic field strength of 1 to 10 Tesla. Thus, depending on the physical configuration of the magnet and applied current, the magnetic field strength in the layer 130 of feed material can range from 50 gauss to 15 Tesla.

Where the powder is fused by selective heating, e.g., laser sintering or laser melting, the magnetic field need not span the entire layer 120 of powder. Rather, the magnet 200 can be configured to apply the magnetic field 202 to just a region, consistent with the desired direction of the magnetic field, that includes the portion of the layer 120 that is being fused. For example, as shown in FIG. 1, the magnetic field 202 is applied in a second localized region that larger than a first localized region where the laser beam 124 strikes the deposited material 120, but smaller than the whole layer. Alternatively, the magnet 200 can be configured to generate a magnetic field 202 that covers the entire layer 120 of powder.

In contrast, where the powder is fused by heating the entire layer 120 simultaneously, e.g., with a heat lamp array, the magnet 200 is configured to generate a magnetic field 202 that covers the entire layer 120 of powder.

The extent of the coverage of the layer 120 by the magnet is a function of size and positioning of the magnet. For example, to cover the entire layer, permanent magnets can be positioned, or electromagnets can have coils that similarly span the entire layer (e.g., see the coils in FIG. 3).

Smaller permanent magnets or coils that span a smaller area can be used to create a magnetic field that does not cover all of the layer 120. If the magnets do not cover all of the layer 120, then the magnet may be connected to a drive system. For example, where the field is parallel to the layer, the magnet can be coupled to a linear actuator to provide motion in a direction perpendicular to the magnetic field lines. As another example, where the field is perpendicular to the layer, the magnet can be coupled to a pair of linear actuators to provide motion in perpendicular directions that are parallel to the layer.

FIG. 1 shows a schematic of an exemplary additive manufacturing system in which the magnet assembly 200 includes two magnets 204, 206 oriented to provide a magnetic field 202 parallel to the surface of the layer 120 of feed material. For example, assuming the magnets 204, 206 are electromagnets, the coils of the electromagnets wind around a horizontal axis.

During operation, the magnetic assembly is positioned so that magnets 204, 206 are on opposite lateral sides of the support 102. For example, the magnets 204, 206 can be positioned laterally outward of the walls 108. For this situation, the walls 108 should be a material that does not interfere with the magnetic field 202.

Having the magnetic field lines parallel to the layer can produce grains having horizontal orientation. If subsequent layers undergo the same process the overall material will have a grain structure that has its strongest conductivity in that same horizontal direction.

FIG. 2 shows a schematic of an additive manufacturing system that is similar to the system illustrated in FIG. 1, but with a roller 158 instead of a material dispenser. The magnetic field 202 produced by magnets 204, 206 is directed parallel to the surface of the layer 120 of material. This orientation allows for grains that will be aligned horizontal to the layer.

FIG. 3 shows a schematic of an additive manufacturing system that is similar to the system illustrated in FIG. 1, but with an energy source provided by a lamp array 302 instead of a laser. For example, the lamp array 302 can include a plurality of infrared lamps.

In addition, in the system of FIG. 3, the magnetic field 202 produced by magnets 204, 206 is perpendicular to the surface of the layer of material. For example, assuming the magnets 204, 206 are electromagnets, the coils of the electromagnets can wind around a vertical axis. The magnets 204, 206 are positioned above and below the support 102. For this situation, the platen 106 should be a material that does not interfere with the magnetic field 202. This magnetic field orientation directed perpendicular to the material's surface can produce grains orientated vertical to the surface of layer 120.

Of course, the magnet 200 configured to generate the magnetic field 202 with field lines perpendicular to the layer 120 of feed material can be combined with the selective heating, e.g., the laser, and/or with the dispenser shown in FIG. 2.

If the magnet 200 is configured to generate a magnetic field that covers the entire area being heated by the lamp array, then the entire layer can be aligned at once. The magnetic field can be applied perpendicularly to each layers of the material in order to produce a product that contains uniform grain orientation with conductivity favoring the vertical with respect to the layer.

Although magnet 204 is illustrated as between the support 102 and the lamp array 302, the coils can be sufficiently large that heat from the lamp array passes through the center opening of the coils.

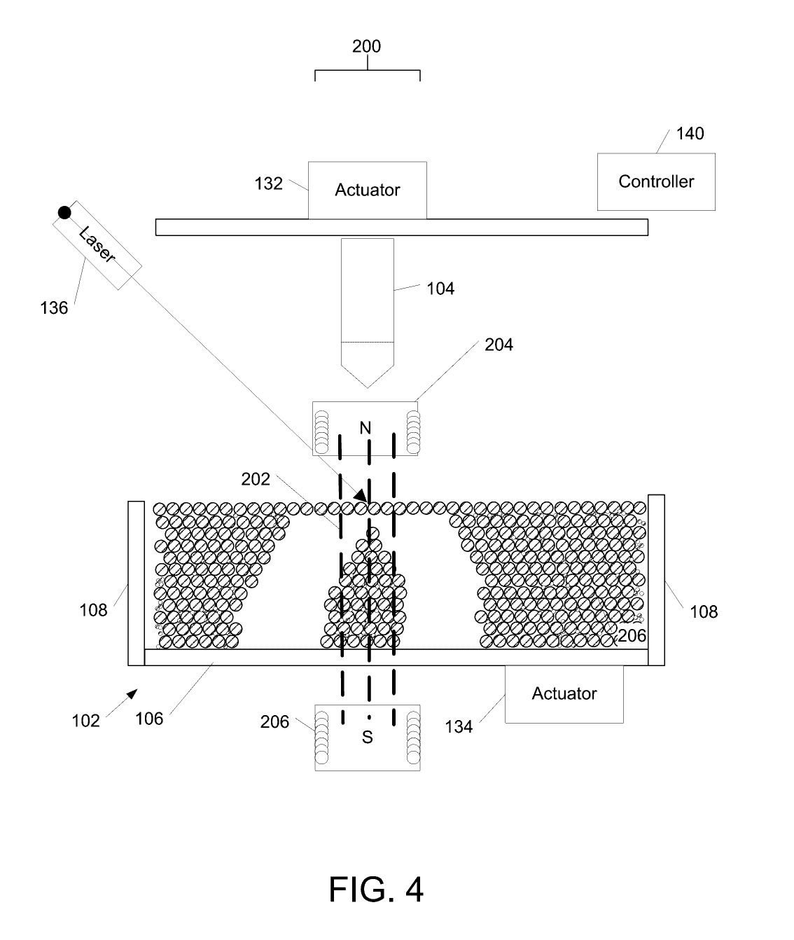

FIG. 4 shows a schematic of an additive manufacturing system similar to the system shown in FIG. 1, but with the magnetic field 202 produced by magnets 204, 206 directed perpendicular to the surface of the layer 120 of feed material. In addition, in contrast to the system shown in FIG. 3, the magnet 200 is sized and configured to apply a magnetic field to less than all of the layer 120. The magnetic field can be applied to just a region around where the layer is being fused, e.g., where laser sintering or melting occurs. The magnets 204, 206 are positioned vertically on either side of the support 102 where the newly deposited material is being sintered by the laser heat source 136. The magnet 204, 206 can be secured to one or more linear actuators controlled by the controller 140 to move in conjunction with the position of the laser 124 on the layer 120. Alternatively, both the laser 124 and magnets 204, 206 could be stationary, and the support 106 could move.

The magnetic field can be applied perpendicularly to each layer of the material in order to produce a uniform grain distribution that is vertical to the surface of material deposition and that will allow for the greatest conductivity in that vertical direction.

In general, for any of these implementations, by applying a magnetic field with the same orientation and intensity to each layer, the layer can be provided with a more uniform grain orientation and grain size throughout. In addition, this tend to create larger grains and reduce the number of grain boundaries, which can both decrease the tensile strength and increase thermal conductivity, compared to objects manufactured without the magnetic field.

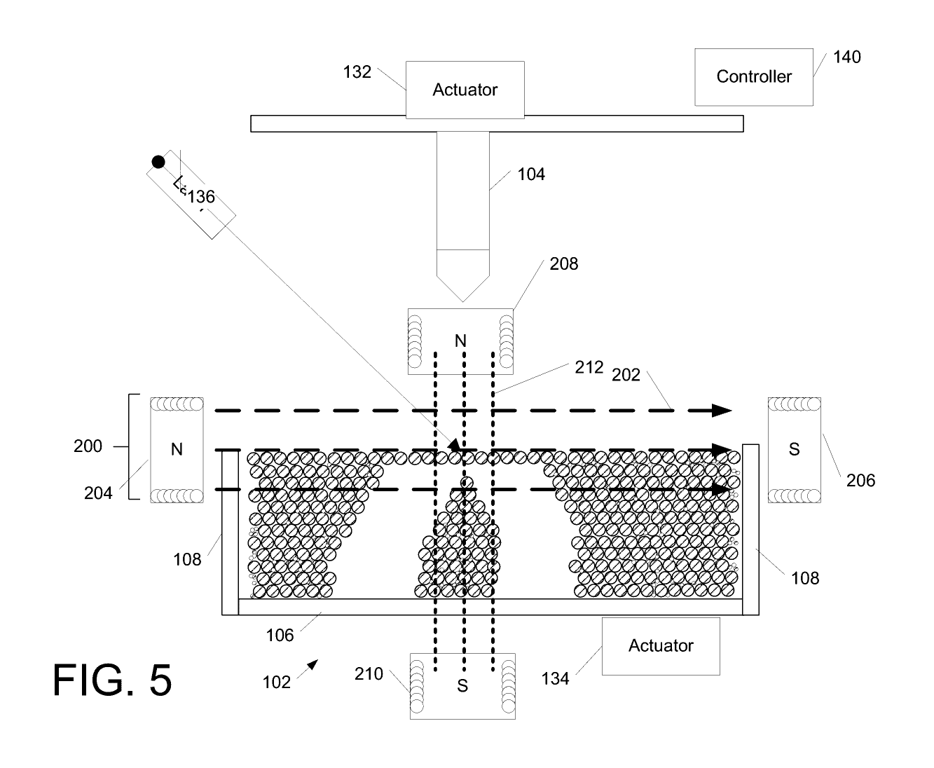

FIG. 5 shows an additive manufacturing system similar to the system shown in FIG. 1, but with two magnet assemblies that can generate magnetic fields in two perpendicular directions. For example, the magnets can be oriented and configured to apply magnetic fields 202, 212 that are parallel and perpendicular, respectively to the layer 120 of material. These fields 212, 202 are produced by two electromagnets 208, 210 positioned above and below the support 102 and two electromagnets 204, 206 on either side of the support 102, respectively.

By controlling the power applied to the electromagnets 204, 206 relative to the power applied to the electromagnets 208, 210, the magnetic field can be applied at a selectable angle of inclination relative to the layer 120. This permits many different orientation combinations for each layer of material.

In addition, by alternating which electromagnets are active for which layer or which voxel, the apparatus 100 is capable of producing having a material with grain alignments that are selectable on a layer-by-layer basis or a voxel-by-voxel basis. For example, by alternating the grain alignments for alternating layers, it may be possible to produce material with reduced thermal conductivity but with increased tensile strength.

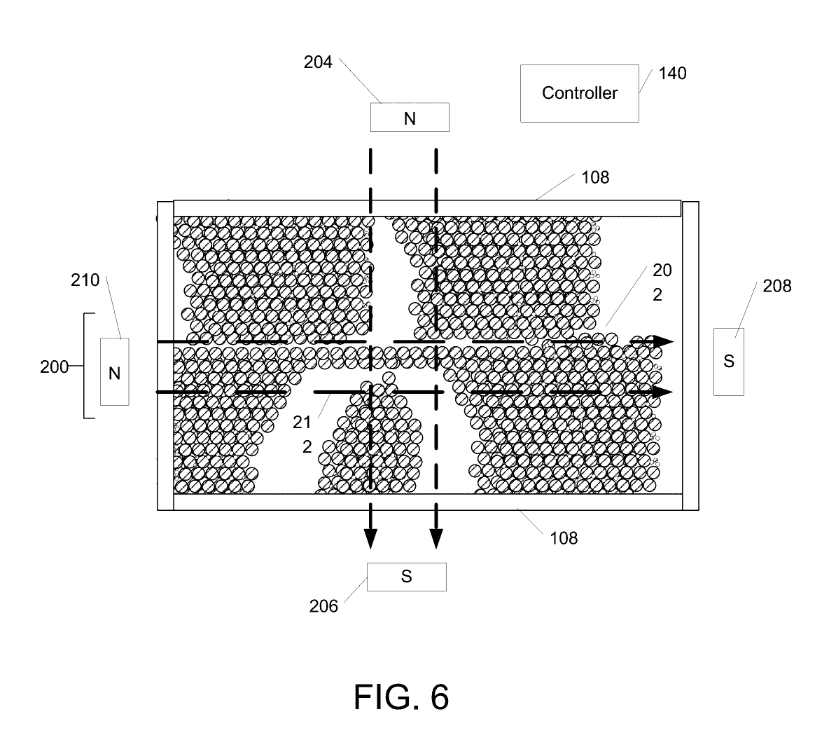

FIG. 6 shows a schematic top view of an additive manufacturing system that is similar to the apparatus shown in FIG. 1, but with two magnet assemblies that can generate magnetic fields 202, 212 in two perpendicular directions, both of which are parallel to the layer 102. In particular, the magnetic field 202 is produced by magnets 204, 206 positioned on two opposite lateral sides of the support 102, and the magnetic field 212 is produced by magnets 208, 210 on another two opposite lateral sides of the support 102. By controlling the power applied to the electromagnets 204, 206 relative to the power applied to the electromagnets 208, 210, the magnetic field can be applied at a selectable orientation that is parallel to the layer 120. The magnets can span the entire length of walls 108.

By changing the direction of the magnetic field for alternating planes of the deposited material, an object can be formed with the grains in the alternating layers having alternating orientations. In general, in contrast to using the same field orientation for each layer, alternating orientations of the grains between layers will create smaller grains and increase the number of grain boundaries, which can both increase the tensile strength and reduce thermal conductivity.

Although FIGS. 5 and 6 show a laser, they could be used with a system that heats the entire layer simultaneously. Moreover, the magnets can be configured to generate the magnetic fields 202, 212 over the entire area of the deposited material, e.g., as shown in FIG. 3.

The controller 140 also controls the voltage source that supplies power to the electromagnets, and thus controls the strength of the magnetic field that they produce.

During manufacturing, layers of feed materials are progressively deposited and fused, e.g., sintered or melted. While they are deposited they are subject to a magnetic field along one or more directions, which will align and control grains within the material. As noted above, the magnetic field can be applied specifically during the period of time when the grains within the material begin to cool. Thus, the grains formed in the layer should be more uniformly aligned along the direction of the magnetic field. Similarly, the size of the grains should be more uniform.

As illustrated in FIGS. 1-4, the energy source 136 can be positioned “above” where the feed material is deposited, and spaced away sufficiently from the electromagnets so as not to cause any interference with the magnetic field during the additive manufacturing process. Similarly, the components of the dispenser can be moved out of the way so as not to interfere with the energy source or the magnets.

The energy source 136 can include a laser that generates a laser beam that is appropriately shaped, for example, using cylindrical lenses, to achieve a line shape. When a line of laser beam is used, the laser beam would be scanned across the top layer of material to cover the portion of deposited feed material being fabricated within the magnetic field. Alternatively, as noted above, the energy source can include an electron source that generates an electron beam.

The use of magnetic fields to cause grain alignment in a layer of feed material also enables layer characteristics of the feed material to be easily controlled. For example, the layer of feed material can be strengthened by selectively aligning the grains in the same direction throughout the material. The alignment direction can be varied layer by layer. The alignment of grains can also be used to design a method of stress failure in the layer of feed material.

The orientation of the magnetic field 200 can changed for different layers throughout the additive manufacturing assembly 100. This can be achieved either through physical movement of the permanent magnets 204, 206; or by using a single electromagnet or electromagnet pair, but reversing direction of magnetic field for alternating layers.

In addition to controlling the orientation of the crystallographic lattice of the grains, for some regimes it may be possible to control the longitudinal axes of the grains. This can generate a material with different properties along the longitudinal axis of the grain versus perpendicular to the grain.

For some implementations, application of the magnetic field can assist in compaction of the powder on the support.

The controller 140 is connected to the various components of the system, e.g., actuators, valves, and voltage sources, to generate signals to those components and coordinate the operation and cause the system to carry out the various functional operations or sequence of steps described above. The controller can be implemented in digital electronic circuitry, or in computer software, firmware, or hardware. For example, the controller can include a processor to execute a computer program as stored in a computer program product, e.g., in a non-transitory machine readable storage medium. Such a computer program (also known as a program, software, software application, or code) can be written in any form of programming language, including compiled or interpreted languages, and it can be deployed in any form, including as a standalone program or as a module, component, subroutine, or other unit suitable for use in a computing environment.

As noted above, the controller 140 can include non-transitory computer readable medium to store a data object, e.g., a computer aided design (CAD)-compatible file, that identifies the pattern in which the feed material should be deposited for each layer. For example, the data object could be a STL-formatted file, a 3D Manufacturing Format (3MF) file, or an Additive Manufacturing File Format (AMF) file. For example, the controller could receive the data object from a remote computer. A processor in the controller 140, e.g., as controlled by firmware or software, can interpret the data object received from the computer to generate the set of signals necessary to control the components of the system to print the specified pattern for each layer.

A number of implementations have been described. Nevertheless, it will be understood that various modifications may be made. Accordingly, other implementations are within the scope of the following claims.

What is claimed is:

1. An additive manufacturing system, comprising:
a support;
a dispenser to deliver a layer of metallic powder onto the support or an underlying layer on the support;
an energy source to fuse at least a portion of the layer of metallic powder; and
a magnet positioned and configured to apply a magnetic field to the portion of the layer of metallic powder as the layer is processed.

2. The system of claim 1, wherein the magnet is oriented such that magnetic field lines of the magnetic field passing through the portion of the layer extend perpendicular to the layer.

3. The system of claim 1, wherein the magnet is oriented such that magnetic field lines of the magnetic field passing through the portion of the layer extend perpendicular to the layer.

4. The system of claim 1, wherein the magnet comprises an electromagnet, and wherein the system comprises a controller coupled to the electromagnet and the energy source.

5. The system of claim 4, wherein the electromagnet comprises a first electromagnet to generate a first magnetic field and a second electromagnet to generate a second first magnetic field substantially perpendicular to the first magnetic field.

6. The system of claim 5, wherein the controller is configured to control power to the first electromagnet and second electromagnet so as to generate a magnetic field in the portion of the layer at a selectable orientation.

7. The system of claim 5, wherein the controller is configured to control power to the electromagnet such that the magnetic field has a first orientation during processing of powder of a first layer and a different second orientation during processing of powder of a subsequent second layer.

8. The system of claim 7, wherein the first orientation is perpendicular to the second orientation.

9. The system of claim 4, wherein the controller is configured to control power to the electromagnet such that the magnetic field has a same orientation during fusing of powder of a first layer and an adjacent second layer.

10. The system of claim 4, wherein the controller is configured to control power to the electromagnet to start generating the magnetic field in the portion of the layer of metallic powder while the portion is being heated by the energy source.

11. The system of claim 4, wherein the controller is configured to control power to the electromagnet to start generating the magnetic field in the portion of the layer of metallic powder while the portion is cooling from being heated by the energy source.

12. The system of claim 1, wherein the magnet comprises a permanent magnet.

13. The system of claim 1, wherein the magnet is configured to apply the magnetic field across all of the layer of metallic powder.

14. The system of claim 13, wherein the energy source is configured to apply heat to raise the temperature of all of the layer of metallic powder simultaneously.

15. The system of claim 14, wherein the energy source is configured to apply heat to raise the temperature in a first localized region of the layer of metallic powder and to scan the region across the layer.

16. The system of claim 1, wherein the energy source is configured to apply heat in a first localized region of the layer of metallic powder and to scan the region across the layer, and wherein the magnet is configured to generate the magnetic field in a second localized region that includes the first localized region.

17. The system of claim 1, wherein the magnet comprises a pair of magnets positioned on opposite sides of the platen.

18. The system of claim 17, wherein the pair of magnets comprise electromagnets having collinear coils.

19. The system of claim 1, comprising a linear actuator coupled to the support to move the support vertically.

20. An method of additive manufacturing, comprising:
delivering a layer of metallic powder onto a support or an underlying layer on the support;
processing at least a portion of the layer of metallic powder to fuse the portion; and
applying a magnetic field to the portion of the layer of metallic powder as the portion is processed.
